(19) United States
(12) Patent Application Publication
(10) Pub. No.: US 2009/0204889 A1
(43) Pub. Date: Aug. 13, 2009

(54) ADAPTIVE SAMPLING OF WEB PAGES FOR EXTRACTION

(76) Inventors: Rupesh R. Mehta, Maharashtra (IN); V.G. Vinod Vydiswaran, Palakkad (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/030,301

(22) Filed: Feb. 13, 2008

(51) Int. Cl. G06F 17/00

(52) U.S. Cl. 715/246

(57) ABSTRACT

Techniques are provided for improving the recall rate of an information extraction system by automatically selecting pages to surface to a user for annotation based on variation data. Techniques are provided for generating the variation data during the construction of the template that is to be used for extraction. During template construction, data is stored to indicate which template-construction pages saw or made changes to nodes in the template. After interesting nodes have been identified in the template, the data stored during template construction is used to determine which pages made changes to interesting-variation nodes. Techniques are also provided for generating the variation data during the extraction phase, when the template is being used to extract information from pages. During the extraction phase, variation data is generated in response to detecting that extraction for a given page resulted in one or more empty attributes.

### RELATED APPLICATIONS

This application is related to U.S. patent application Ser. No. 11/945,749, filed Nov. 27, 2007, entitled “Techniques For Inducing High Quality Structural Templates For Electronic Documents” by V. G. Vinod Vydiswaran, Rupesh Mehta, and Amit Madaan, the contents of which are incorporated herein by reference.

This application is also related to U.S. patent application Ser. No. 11/938,736 filed on Nov. 12, 2007, entitled “Extracting Information Based On Document Structure And Characteristics Of Attributes” by V. G. Vinod Vydiswaran, Charu Tiwari, and Arun Ramanujapuram, (the “Extraction Application”), the contents of which are incorporated herein by reference.

### FIELD OF THE INVENTION

The present invention relates to information extraction systems and, more specifically, to automated selection of pages to surface for annotation.

### BACKGROUND

Web pages frequently have many different sections. Often, different sections correspond to different classes of content. For example, a web page for an online newspaper may use one section of the page to show the headlines, another section of the page to show a table of contents, another section of the page to show the main article, and yet another section of the page to show advertisements.

The process of extracting information out of existing web pages is referred to as Information Extraction. When performing Information Extraction, it is important to know which sections of the web page have which classes of content. For example, in the context of a search engine, it may be desirable to index web pages based on content from the main articles of the web pages, rather than on content from the advertisements that may be on the web pages.

Information Extraction over the Web is a challenging problem, and is complicated further by the large volumes of data and the multitude of content classes. Many on-line merchants use scripts to present their data in a semi-structured format to generate a uniform look-and-feel template and present the information at strategic locations in a template. Identifying such positions on a page and extracting and indexing relevant information to provide end users a significantly better search experience is primary to the success of any data-centric application, such as search engines.

Several techniques, from the rule based to statistical machine learning, are being applied for the purpose of extracting information from web pages. In their most generic form, such techniques involve the use of Wrappers, also known as structural templates. Structural templates contain information for determining how a web page is sectioned, and consequently which data in the web page corresponds to which content classes.

Unfortunately, it is common for there to be variations in the structure of web pages, even when the web pages are from the same site. Because of such variations, a template that is being used to extract information from the web pages of a particular site may not be able to extract information from all web pages of the site. Assuming that each web page includes information for a single entity (e.g. information about a single product), the percentage of pages of a site from which information can be correctly extracted using a template is referred to as the “recall” of the template. The higher the recall of the template, the greater the percentage of pages from which information can be extracted.

In addition to recall, the value of a template is also measured by the accuracy of the information extractions. The accuracy of extractions is referred to as the “precision” of the template. For example, assume that a template is able to extract titles from 80 of 100 pages from a site, and that 40 of those 80 extracted titles are actually titles. Under these conditions, the recall of the template would be 40%, and the precision of the template would be 50%. Thus, both precision and recall are important aspects of information extraction techniques.

To train an extraction system that uses a template, humans are often used to identify and mark strategic locations in web pages. The process of marking strategic locations in web pages is referred to as annotating the web pages. Once a web page has been annotated, an information extraction system can be trained using the annotated page to extract information from other structurally similar pages.

For example, one existing extraction system works as follows: Given a set of webpages, a human is first requested to identify pages of interest (those having relevant information). Once pages of interest have been identified, the human detects representative pages to annotate based on visual differences in the pages. The pages selected for annotation are referred to herein as “to-be-annotated pages”.

Once a human has selected the to-be-annotated pages from the relevant web pages, the human annotates interesting attributes (such as Title, Price, Image, and Description for Shopping pages) in those selected pages. Pages that have been annotated are referred to herein as “annotated pages”. The extraction system, which includes the template and filters, is then trained using a set of pages that includes the annotated pages. Once trained, the system applies the template on other pages to extract the attributes-of-interest from them.

In such a system, a human employs “eye-balling” to choose the to-be-annotated pages by selecting appropriate samples from a set of structurally similar pages. Clearly, such a human-driven sampling is non-trivial, cumbersome, erroneous, prone to omissions, and does not guarantee the selection of appropriate samples as visually similar pages might differ in their structural representation. Samples chosen at random do not guarantee to cover structural variations in pages and may surface redundant samples to the human for annotation, incurring extra cost of human annotation without a significant improvement to recall.

Unfortunately, it is not uncommon for pages to vary in their structure because of optional, extraneous, or styling sections. Due to small but important structural variations, a high precision extraction system may fail to extract required attributes from pages having such variations, thereby adversely affecting the recall.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating a method for generating variation data during a template-construction phase, according to an embodiment of the invention.

FIG. 2 is a flowchart illustrating a method for generating variation data during an information extraction phase, according to an embodiment of the invention.

FIG. 3 is a block diagram illustrating a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are described herein for automatically selecting pages to be annotated based on structural variations between the pages. Using the techniques, pages are selected for annotation based on how likely their selection is to improve the recall rate of the information extraction system. For example, assume that five pages have already been selected as to-be-annotated pages. Assume further that an annotation system trained based on those five pages would have an 80% recall rate. Assume further that selecting an additional page X for annotation would result in a 90% recall rate, while selecting an additional page Y for annotation would result in an 85% recall rate. Under these conditions, page X would be automatically be selected for annotation. If page X covers all the variations incurred by page Y, then page Y would not be selected for annotation after page X was selected. However, if page Y includes variations not covered by page X, then page Y may also be selected, to further improve the recall rate.

By selecting pages for annotation based on how much their selection will improve the recall rate of the system, a greater number of structural variations will be reflected in the set of annotated pages. When trained based on the annotated pages, the recall of an information extraction system is improved without necessarily increasing the number of annotated pages by which the system is trained.

Techniques are provided for generating variation data during the construction of a template for a set of pages. The variation data indicates which pages have content that corresponds to nodes within the template. After a user identifies which nodes of the template are of interest, the variation data associated with those nodes is used to automatically select pages to surface to a user for user annotation.

Techniques are also provided for increasing recall after the information extraction system has been initially trained. For example, if the initial training of the information extraction system does not result in an acceptable recall rate, additional annotated pages may be used to provide supplemental training to the system to improve recall. Techniques are described hereafter for automatically selecting which additional pages to annotate for the supplemental training. The automatic selection is performed in a manner to maximize the improvement in recall of the system while minimizing the number of additional pages that need to be annotated.

### Template-Construction

An initial step in training an information extraction system to extract information from a set of web pages involves constructing a template for the set of web pages. In one embodiment, the template is a regular expression that defines the structure of a set of web pages. When the set of pages for which a template is being generated is very large, the template may be generated based on a subset of the web pages. For example, a template for a web site that has thousands of web pages may be generated based on a few hundred pages randomly selected from the web site. The pages that are used during the construction of the template are referred to herein as template-construction pages. Details about how a template may be constructed are described in the Extraction Application identified above.

### Template Generalization Operators (STARS, HOOKS and ORS)

During template-construction, the template-construction pages are processed one by one. An initial template may be generated based on the DOM of the first template-construction page that is processed. As each additional template-construction page is processed, a DOM is created based on the page, and the template is updated as needed to take into account the structure of the page. Specifically, when a template-construction page exhibits a structural variation that is not reflected in any previously-processed template-construction page, the DOM of the page will have a node that does not match the current template, due to the structural variation. When the DOM of a template-construction page has a node that does not match the current template, a “mismatch” is said to have occurred. When a mismatch occurs, a new operator is added to the template to take into account the new node. The specific operator that is added to the template in response to a mismatch is based on the relationship of the non-matching node to nodes that do match the current template. Three such operators are: STAR, HOOK and OR.

A STAR operator indicates that any subtrees that stem from children of the STAR operator are allowed to occur one or more times. A HOOK operator indicates that the underlying subtrees are optional. In one embodiment, a HOOK operator is allowed to have only one underlying subtree. In other words, a HOOK operator is allowed to have only a single child, in one embodiment. An OR operator in the template indicates that only one of the sub-trees underlying the OR operator is allowed to occur at the corresponding position in the DOM of a page. STAR, HOOK and OR operators are described in detail in the Extraction Application.

### Generating Variation Data During Template-Construction

According to one embodiment, during template-construction, the system keeps track of which template-construction pages “make” or “see” changes to the template. In this context, a template-construction page “makes” a change to the template if a mismatch between the template and the DOM of the template-construction page causes the change to be added to the template. On the other hand, a template-construction page “sees” a change in the template if the DOM of the template-construction page has a node that would have caused the change to be added to the template, but the change was previously added to the template because of a previously-processed template-construction page.

For example, assume that page 1 has caused OP to be added at location X within the template. Because OP was added at location X, a page 2 maps correctly to the template. But if page 2 had been matched with the template before page 1, then page 2 would have caused the same change to be made to the template at location X. In such case, page 1 has “made” the change and page 2 has “seen” the change made by page 1. The page that made the change, and the pages that see the change, are collectively referred to as the pages that are “covered” by the change. According to embodiment, variation data tracks the pages that are covered by each change to the template.

According to one embodiment, the variation data is stored within the template itself. Specifically, at the location of each change, the template is updated to indicate (a) which pages made or saw the change, and (b) a “support count” that indicates the total number of pages that are covered by the change. For example, when page 1 causes the addition of OP at location X, variation data is stored at location X that (a) identifies page 1 and (b) initially sets the support count of location X to 1. When page 2 then “sees” OP at location X, an identifier for page 2 is added to location X and the support count of location X is incremented to 2. This process is repeated for every template-construction page. Consequently, at the end of the template-construction phase, the variation data will include, for each change made to the template, a support count that indicates how many template-construction pages have nodes that are covered by the change, and the identifiers of the specific template-construction pages that have nodes that are covered by the change.

### Flowchart for Variation Data Generation

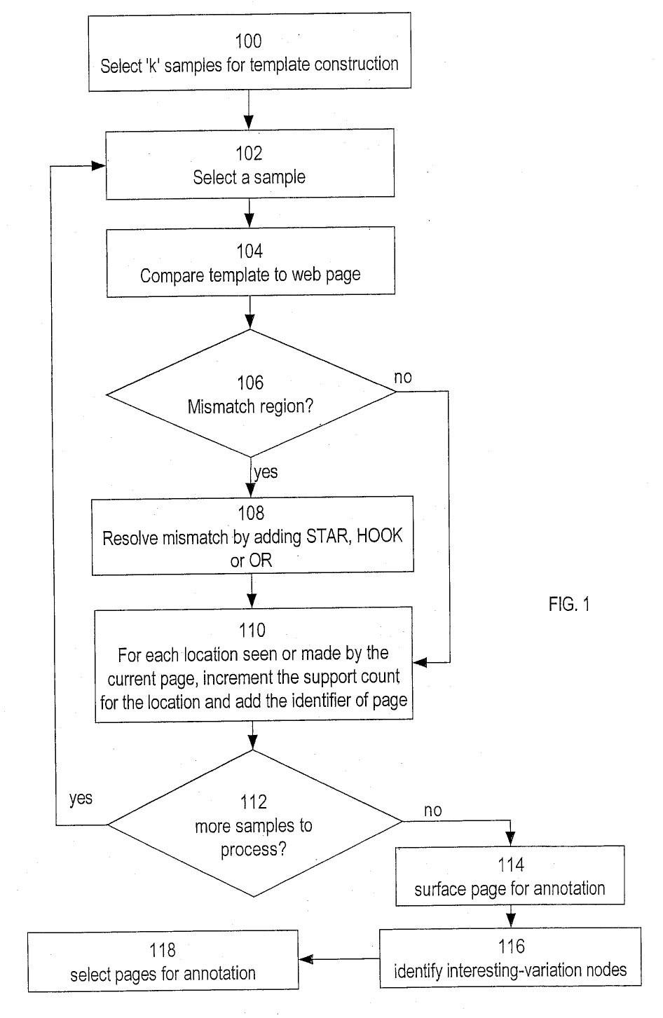

FIG. 1 is a flowchart that illustrates steps of generating variation data during the template-construction phase. Given a cluster of pages, a template is constructed and information on structural variations among template-construction pages is collected. Specifically, the information on structural variations that is learned is the list of identifiers of template-construction pages making or seeing each change, and the support count for each change i.e. the number of web pages making or seeing that change.

Referring to FIG. 1, at step 100, ‘k’ samples are selected as template-construction pages. For smaller sets of pages, k may include all pages in the set. However, for most large sets of pages, k will be a subset of the pages in the set. When k is a subset of the pages for which the template is to be used, the k samples may be selected using any one of a variety of techniques. For example, the k samples may be selected using random sampling, ‘k’-distinct sampling, or ‘k’ representative sampling. Control then passes to step 102.

At step 102, a sample is selected from among the k samples. At step 104, the structural template is compared to the DOM of the current sample, as described in the Extraction Application. At step 106, it is determined whether mismatches exists between the template and some region of the DOM of the current sample. If some region mismatches, the mismatch is resolved by adding a STAR, HOOK, or OR operator to the template, as described in the Extraction Application.

In addition to updating the template, at step 110 the system finds out changes seen or made to the template (i.e. additions of HOOK and OR operators) by the current page. For each such change, the variation data is updated. In one embodiment, the variation data is updated by adding the URL of the current page (or URL ID) to each changed location within the template, and increment the support count of each changed location in the template by one.

The changes made or seen by the current page can be determined based on the mapping between the DOM of the current page and the template. Specifically, for each HOOK node present in the template, a check is made to see if the HOOK's parent template node has a mapping to a corresponding DOM node and the HOOK's child template node does not have a mapping to any DOM node. In this case, the current page has made or seen the change in the template structure to contain this HOOK node, and hence the system updates the variation information for the HOOK node (i.e. adds the current URL or URL ID to the node's sample list). In addition, the node's support count is increased by one. Otherwise, this HOOK node was not made or seen by the current page.

For each OR node present in the template, the system determines the OR node's children's mapping to the Web-page structure of the current page. When a child template node(s) maps to the current page structure, the current page made or sees the change to the template. Hence, information for such nodes are updated (i.e. by adding the current URL or URL ID to node's sample list and increment node's support count by one).

At step 112, it is determined whether all of the k samples have been processes. If any of the k samples have not been processed, control proceeds to step 102. Otherwise, control proceeds to step 114, where pages a page is surfaced for annotation. After a page has been annotated, interesting variation nodes are identified (step 116), and additional pages are automatically selected for annotation (step 118) based on the variation information generated at step 110 during the processing of the k samples.

### Identifying Interesting Nodes

Once the template learning and structural change information computation is done on ‘k’ template-construction pages, a first page is presented (“surfaced”) to a human for annotation. The first page presented to a human for annotation may be selected using a variety of techniques. For example, in one embodiment, the first page presented to the human for annotation is randomly selected page. Alternatively, a page that is determined to be a “most representative” page may be presented as the first page for human annotation.

The annotations that the human makes to the first to-be-annotated page identify what portions of the page are “interesting” to the user. The attributes that are identified as interesting are the attributes that the information extraction system will be trained to extract. For example, the user may identify as “interesting” the title and main article of a web page from an online magazine site.

Once the first to-be-annotated page has been annotated, the page is mapped to the learnt template. The nodes of the template that map to the annotated nodes of the first to-be-annotated page are referred to herein as the “interesting nodes”. In this context, an interesting node is defined as a node corresponding to an annotated page structure node. After the interesting nodes have been identified, a set of interesting-variation nodes are identified. After the interesting-variation nodes are identified, to-be-annotated pages are automatically selected based on the variation data associated with the interesting-variation nodes.

### Identifying Interesting-Variation Nodes

Interesting-variation nodes are identified based on (a) the interesting nodes, and (b) the template. According to one embodiment, for each interesting node, the system looks for the presence of HOOK or OR nodes in the path from the interesting node to root node. If a HOOK node is present in the path, then the system remembers (a) the HOOK node address (unique ID in the template), (b) the sample list associated with the node, and (c) the support count associated with the node.

Similarly, if an OR node is present in the path from an interesting node to the root node, then the system remembers (a) each non-annotated OR child node's address, (b) the sample list associated with each non-annotated OR child node, and (c) support count associated with each non-annotated OR child node. The HOOK and OR nodes remembered during this process are collectively the “interesting-variation nodes” of the template.

### Generating Tuple-Lists Based on Variation Data of the Interesting-Variation Nodes

After the interesting-variation nodes have been identified, the sample lists associated with the interesting-variation nodes are used to construct a mapping between each template-construction page (i.e. URL or URL ID) and a set of tuples. The set of tuples to which a given template-construction page is mapped is referred to herein as the “tuple list” of the template-construction page. Specifically, each tuple in the tuple list for a given template-construction page includes (a) the address of an interesting-variation node in whose sample list the given template-construction page was listed, and (b) the support count associated with the interesting-variation node.

For example, assuming that template-construction page Si is in the sample list of interesting-variation nodes located at addresses dr1 to addrN, template-construction page Si would be mapped to a set of tuples that include {<addr1, support_count >, <addr2, support_count2>,...,<addrN, support_countN>}. Once the tuple-list of each template-construction page has been generated, the tuple lists are used to automatically select which additional pages will be surfaced for user annotation.

### Selecting to-Be-Annotated Pages Based on Tuple-Lists

The tuple lists of different template-construction pages could have some addresses in common. For example, if both page X and page Y saw the same change in an interesting-variation node Z of the template, then the tuple lists of both page X and page Y will have the tuple <addrZ, support_countZ>. Thus, a user does not have to annotate all template-construction pages in order to cover all structural variations involving interesting nodes. Therefore, to minimize the number of template-construction pages that need to be annotated to cover the structural variations of all of the interesting nodes, techniques are provided for automatically selecting a minimal set of template-construction pages, which cover all interesting node variations mapped by any of the template-construction pages.

According to one embodiment, a minimal representative sample set detection technique involves initializing an address list, addrList={} and a sample list, samList={}. After initialization, both lists are empty. Once the lists are initialized, members are added to the lists by performing the following steps until each interesting-variation node address is covered:
STEP1: Choose the sample, Si, having highest number of ‘uncovered’ addresses and add the identifier of the sample to samList, i.e. samList=samList U {Si}.
STEP2: Add all addresses mapping to the sample to the addrList. (i.e. addrList=addrList U {addresses mapping to Si}).

Interesting-variation node addresses that have been added to the address list are considered “covered”. Therefore, because the address list is initially empty, the first iteration of STEP1 involves choosing the template-construction page that has the most tuples in its tuple-list. In STEP2, the addresses in the tuple-list of the template-construction page selected in STEP1 are added to the address list, thereby indicating that those addresses are now “covered”.

STEP1 and STEP2 are repeated until the addresses of all interesting-variation nodes are covered. At that point, the sample list samList will include identifiers for a subset of the template-construction pages. When selected in the manner described herein, the subset of template-construction pages included in the sample list will cover all structural variations, of the interesting nodes, that were seen during template-construction. In addition, because the to-be-surfaced pages were selected based on how many not-yet-covered interesting-variations that they cover, the number of pages that need to be annotated to cover all of the interesting-variation nodes is minimized (although not guaranteed to be the absolute minimum).

These automatically selected pages may then be surfaced to the user for annotation. After the pages in this subset have been annotated, the information extraction system is trained based on the annotated pages. Once trained based on annotated pages selected in this manner, the recall rate of the information extraction system should be significantly higher than what the recall rate would be if the surfaced pages were randomly selected (or selected based on eye-balling).

### All-Inclusive Template-Construction

In the process described above, the template-construction pages are a selected subset of the set of pages from which the template is to be used to extract information. Because template-construction pages were only a subset of the set of pages from which the template is to be used to extract information, there is no way to be sure of the exact impact that annotating a particular page will have on the recall of the extraction operation. For example, a first page may map to 20 interesting-variation node addresses, while a second page maps to 100 interesting-variation node addresses. Even though the second page maps to significantly more interesting-variation node addresses, annotating the first page may actually improve the recall rate more than annotating the second page, because the structural variations reflected in the first page may be present in more pages of the set, than the structural variations reflected in the second page.

If the ‘k’ pages that are chosen as template-construction pages do not fully represent all kinds of structural variations in that set of pages from which information is to be extracted, selecting to-be-annotated pages based on the variations that exist in the ‘k’ pages may not achieve a required level of recall. Therefore, in one embodiment, all pages (instead of ‘k’ samples) are used to compute the required set of samples for human annotations. With consideration of all pages, the system can impose an additional constraint of sample ordering, and could select a minimal set of samples to achieve required recall.

Specifically, assume that all pages in the set were used as template-construction pages. Under these conditions, the samples may be ordered based on their importance i.e. support count. A sample's support count, ssc, is defined as the sum of support counts of all “uncovered” addresses in the tuple list of the sample. For example, the support count for Sample Si is equal to (support_count+support_count2+...+support_countN), where ‘N’ is number of uncovered addresses. The sample support count, ssc, gives an indication that inclusion of this sample in the training set would help to extract at least ssc number of attributes.

In an embodiment that uses the support count of a page as a factor in deciding whether to surface the page for annotation, the selection of to-be-annotated pages may proceed as follows:

STEP1: Initialize address list, addrList={} and sample list, samList={}.

STEP2: Iterate over the steps 2A to 2C until all interesting-variation node addresses covered:
2A) Choose the sample, Si having highest support count and add it to samList, i.e. samList=samList U {Si}.
2B) Add all addresses mapping to the sample, Si to the addrList. i.e. addrList=addrList U {addresses mapping to Si}.
2C) Re-compute remaining samples' support count based on covered address list, addrList.

In step 2C, the system does not consider support counts associated with covered addresses while computing the support count. For example, if Sample, Sj maps to {<addr1, support count1>, <addr2, support_count2>, <addr3, support_count3>} and if address, addr3 are covered in addrList, then the system computes Sj's support count as (support_count+support_count2). Selecting to-be-annotated pages in this manner ensures that the pages that are selected are selected in an order that reflects how much impact the annotation of the pages will have on the overall recall rate of the extraction operation.

According to one embodiment, steps 2A to 2C are repeated until the recall rate reaches a predefined goal. For example, the goal may be that 90% of all interesting attributes are extracted. Under these conditions, iteration of steps 2A to 2C may stop before all interesting-variation node addresses are covered. For example, assume that a particular structural variation is only present on a single page X. The support count for the interesting-variation node associated with that structural variation would be 1. If that structural variation is the only structural variation in that page, the sample support count for page X would be 1. Under these conditions, the iteration of steps 2A to 2C may stop before page X is selected as a to-be-annotated page, since annotation of page X would cause the extraction of only a single attribute from a single page.

According to yet another embodiment, steps 2A to 2C are repeated until all interesting-variation nodes are covered. However, the order in which the nodes were added to the sample list, samList is the order in which they are presented to the user for annotation. After each annotation, the information extraction system may be trained, and a new recall rate determined. If the new recall rate achieves the goal, then the user may stop annotating pages, even though the user has not annotated all pages that were added to the sample list.

### Generating Variation Data During Extraction

In the embodiments described above, the to-be-annotated pages are selected based on variation data that is created during template-construction. The extraction system is then trained based on the annotated pages, and extraction is performed. However, as shall be described hereafter, techniques are also provided for automatically selecting to-be-annotated pages based on variation data created during the extraction process itself. Specifically, if an extraction system that has been trained on a first set of annotated pages is not producing the desired recall rate, then the extraction system may be further trained on a second set of annotated pages. Techniques are provided for automatically selecting the to-be-annotated pages to use for a second (or subsequent) round of training based on variation data generated during the extraction process.

Unlike the template-construction phase, during the extraction phase, a learnt template already exists. Further, the learnt template already has annotations which indicate which nodes of the template correspond to interesting attributes. In addition, other extraction-related learnt modules are available, such as filters. When extraction is successfully performed on a page, the extraction system outputs a tuple of extracted attributes. However, for a variety of reasons, the extraction system may fail to extract attribute values from certain pages, such as the current page having some structural variations or the filter scoring mechanism.

According to one embodiment, variation data is generated during the extraction phase based on non-extracted, empty attributes encountered during extraction. The extraction system keeps track of information pertaining to structural or other variations for such attributes, and outputs a minimal, representative sample set to use to further train the extraction system to improve recall during a subsequent extraction phase.

Unlike the scenario described above where variation information is generated during template-construction, during the extraction phase the training phase is already over, where human has annotated a page or set of pages. Further, other extraction system components like filters are also available and may be considered during the to-be-annotated page selection process. In addition, because human input is available, structural variation information is computed only for changes in the regions of the template that have already been identified as “interesting nodes”.

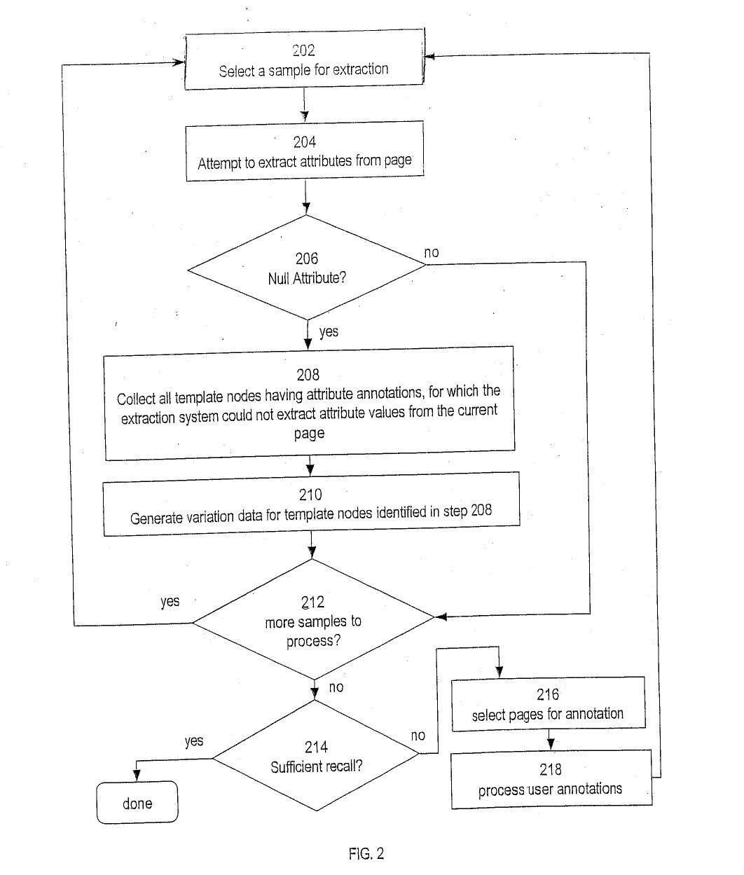

According to one embodiment, variation data is generated during information extraction as illustrated in FIG. 2. Referring to FIG. 2, at step 202 a sample is selected for extraction. The sample may or may not have been one of the pages used to construct the template that is being used to perform the extraction.

At step 204, using the trained template, the extraction system attempts to extract a set of attributes from the page. In one embodiment, the attributes are extracted in the form of a tuple, <attrVal1, attrVal2,..., attrValN>.

At step 206, the tuple generated during step 204 is inspected to determine whether the tuple contains any empty attribute value. If the tuple does not have any empty attribute value, then control proceeds to step 212.

If the tuple does have an empty attribute value, control proceeds to step 208. At step 208, the extraction system collects all template nodes having attribute annotations, for which the extraction system could not extract attribute values from the current page. For example, if for current page, the “Title” attribute has empty value, then all template nodes annotated with “Title” are collected.

For the current page, the template nodes collected in step 208 are treated as interesting nodes for the purpose of identifying interesting-variation nodes. For the interesting nodes collected in step 208, the interesting-variation nodes associated with those nodes are computed (step 210) in a way similar to computing the information on structural variations described above.

If there is no modification to the template structure for a particular attribute done or seen by the current page, then the page is treated as a “non-structural variation” case. This situation may happen if, for example, the extraction mechanism based on non-structural features has failed to identify one appropriate candidate. According to one embodiment, this variation data is stored as a set of records, where each record corresponds to the attribute of an interesting node. The record for a given attribute may include a list of all samples that saw no extraction for that attribute and did not incur any structural variations associated with nodes that correspond to the attribute (i.e. <attrName1>=>{Sa, Si, .., Sj}).

At step 212, the extraction system determines whether there are any more pages on which extraction is to be performed. If there are more pages to be processed, then control passes back to step 202. If all pages have been processed then control passes to step 214.

At step 214, the system determines whether the extraction operation resulted in sufficient recall. If the extraction operation resulted in sufficient recall, then extraction is completed. If the extraction operation did not result in sufficient recall, then control passed to step 216 where additional pages are surfaced for annotation.

The additional pages that are surfaced during step 216 are automatically selected based on the variation data that was generated during step 210 of the extraction process. In step 218, the system receives user annotations of the selected pages. The extraction system is then further trained based on the newly annotated pages, and another round of extraction is performed. Because of the extraction system received additional training, and the pages used for the additional training were selected based on extraction failures that occurred during the previous extraction operation, the subsequent extraction operation will have improved recall.

### Selecting to-Be-annotated Pages Based on Variation Data Generated During Extraction

As mentioned above, the recall of the extraction process is computed when the extraction process finishes. If the computed recall does not meet required recall criteria set by the publisher or system, then two types of sample sets are computed, according to one embodiment. Specifically, according to one embodiment, a minimal, ordered list of representative samples is computed using the techniques described above.

### Attribute Name Support Counts

According to one variation, the technique may be modified to allow the page selection to take into account non-structural learning variations, as well as structural learning variations.

For example, it has previously been described that a support count may be determined for each interesting-variation node addresses based on how many samples are covered by the interesting-variation node. Consequently, each sample may be mapped to a set of tuples such as {<addr1, support_count1>, ..., <addrN, support_countN>}. These tuples are used as one factor in deciding which pages to surface for annotation.

In addition to the <address, support_count> tuples, each sample may also be mapped to a set of <attribute, support_count> tuples. The <attribute, support_count>tuples to which a sample maps correspond to the attributes that the extraction system was unable to extract for the sample. For example, assume that the extraction system was unable to extract attrName1...AttrNameN from sample Si. Consequently, sample Si would map to {<attrName1, support_count1>, ..., <attrNameN, support_countN>}.

In one embodiment, the support count support_counti associated with each attribute name, attrNamei, is computed as the cardinality of the set of samples to which the attribute name maps. For example, assume that the attribute Title maps to 50 samples. Under these conditions, the tuple for the attribute Title would be <Title, 50>.

In one embodiment, the sum of the support counts of the attributes the map to a page are used as a factor in deciding which pages to surface to a user for annotation. In the selection of to-be-annotated pages, the sum of the attribute support counts of samples may be used as a selection factor instead of, or in addition to, the sum of the interesting-variation node support counts of samples.

### Hardware Overview

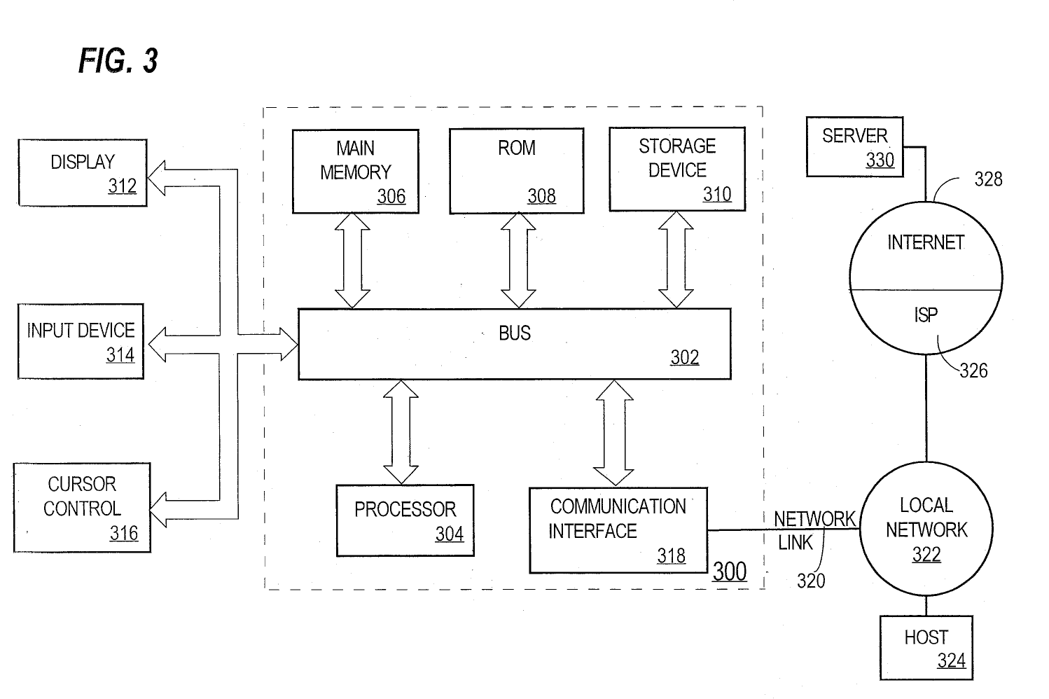

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for automatically selecting pages to surface for annotation, the method comprising the computer-implemented steps of:
during construction of a template to be used for extracting information from a set of pages, making changes to the template based on structural variations that exist in template-construction pages;
in response to making changes to the template during construction of the template, generating variation data that indicates a mapping between (a) changes to the template and (b) template-construction pages that make or see the changes to the template; and
automatically selecting one or more pages to surface for annotation based, at least in part, on said variation data.

2. The method of claim 1 further comprising:
presenting said one or more pages to a user for annotation;
receiving input that annotates said one or more pages;
training said template based on said input; and
using said trained template to extract information from said set of pages.

3. The method of claim 1 wherein the step of automatically selecting one or more pages includes:
receiving from a user data that identifies interesting nodes within the template; and
automatically selecting one or more pages based on variation data associated with interesting-variation nodes that correspond to said interesting nodes.

4. The method of claim 3 wherein:
the user data identifies a particular node as an interesting node; and
the method further includes
looking for HOOK or OR nodes in the path from the particular node to a root node;
if a HOOK node is present in the path, then the establishing the HOOK node as an interesting-variation node of the interesting node; and
if an OR node is present in the path, then the establishing each non-annotated OR child node as an interesting-variation node of the interesting node.

5. The method of claim 3 wherein the step of automatically selecting one or more pages includes:
using the variation data associated with the interesting-variation nodes to construct a mapping between each template-construction page and addresses of interesting-variation nodes;
initializing an address list and a sample list; and
repeating the following steps until each interesting-variation node address is included in the address list:
choosing a template-construction page that maps to a highest number of uncovered addresses of interesting-variation nodes;
adding the identifier of the chosen template-construction page to the sample list; and
adding all addresses mapping to the chosen template-construction page to the address list; and
selecting the one or more pages based on the sample list.

6. The method of claim 3 wherein the step of automatically selecting one or more pages includes:
using the variation data associated with the interesting-variation nodes to construct a mapping between each template-construction page and a tuple list;
wherein the tuple list for a given template-construction page includes support counts for interesting-variation nodes that map to said template-construction page; and
selecting the one or more pages based, at least in part, on the support counts for the interesting-variation nodes that map to said template-construction page.

7. The method of claim 1 wherein:
the method further includes generating, for each the template-construction page, a sum of support counts;
the sum of support counts for each template-construction page is based on the support counts of all not-yet-covered interesting-variation nodes associated with the template-construction page; and
the method further comprises selecting the one or more pages based on the sum of support counts associated with the template-construction pages.

8. The method of claim 7 wherein all pages in the set of pages are used as template-construction pages.

9. The method of claim 7 further comprising:
computing a first sum of support counts for a first template-construction page;
computing a second sum of support counts for a second template-construction page;
based on the first sum of support counts, selecting the first template-construction page as a page to be annotated; and
in response to selecting the first template-construction page as a page to be annotated, re-computing the second sum of support counts for the second template-construction page.

10. The method of claim 9 wherein the method of re-computing the second sum of support counts includes reducing the second sum of support counts based on the support counts of interesting-variation nodes, associated with the second template-construction page, that are covered due to selection of the first template-construction page.

11. A method for automatically selecting pages to surface for annotation, the method comprising the computer-implemented steps of:
during information extraction from a set of pages based on a template, detecting situations in which extraction results in empty attribute values;
in response to detecting a situation in which extraction results in empty attribute values, generating variation data that maps pages that produced empty attribute values to interesting-variation nodes of the template; and
automatically selecting one or more pages to surface for annotation based, at least in part, on said variation data.

12. The method of claim 11 wherein the step of generating variation data includes:
determining an attribute for which a particular page did not generate a value;
identifying, within the template, an interesting-variation node for the attribute; and
associating the particular page with the interesting-variation node.

13. The method of claim 12 further comprising:
determining an attribute for which a particular page did not generate a value;
incrementing a support count associated with the attribute; and
using support counts associated with attributes as a factor in selecting the one or more pages to surface for annotation.

14. A computer-readable storage medium storing instructions for automatically selecting pages to surface for annotation, the instructions including instructions which, when executed by one or more processors, cause the one or more processors to perform the steps of:
during construction of a template to be used for extracting information from a set of pages, making changes to the template based on structural variations that exist in template-construction pages;
in response to making changes to the template during construction of the template, generating variation data that indicates a mapping between (a) changes to the template and (b) template-construction pages that make or see the changes to the template; and
automatically selecting one or more pages to surface for annotation based, at least in part, on said variation data.

15. The computer-readable storage medium of claim 14 further comprising instructions for:
presenting said one or more pages to a user for annotation;
receiving input that annotates said one or more pages;
training said template based on said input; and
using said trained template to extract information from said set of pages.

16. The computer-readable storage medium of claim 14 wherein the step of automatically selecting one or more pages includes:
receiving from a user data that identifies interesting nodes within the template; and
automatically selecting one or more pages based on variation data associated with interesting-variation nodes that correspond to said interesting nodes.

17. The computer-readable storage medium of claim 16 wherein:
the user data identifies a particular node as an interesting node; and
the computer-readable storage medium further comprises instructions for
looking for HOOK or OR nodes in the path from the particular node to a root node;
if a HOOK node is present in the path, then the establishing the HOOK node as an interesting-variation node of the interesting node; and
if an OR node is present in the path, then the establishing each non-annotated OR child node as an interesting-variation node of the interesting node.

18. The computer-readable storage medium of claim 16 wherein the step of automatically selecting one or more pages includes:
using the variation data associated with the interesting-variation nodes to construct a mapping between each template-construction page and addresses of interesting-variation nodes;
initializing an address list and a sample list; and
repeating the following steps until each interesting-variation node address is included in the address list:
choosing a template-construction page that maps to a highest number of uncovered addresses of interesting-variation nodes;
adding the identifier of the chosen template-construction page to the sample list; and
adding all addresses mapping to the chosen template-construction page to the address list; and
selecting the one or more pages based on the sample list.

19. The computer-readable storage medium of claim 16 wherein the step of automatically selecting one or more pages includes:
using the variation data associated with the interesting-variation nodes to construct a mapping between each template-construction page and a tuple list;
wherein the tuple list for a given template-construction page includes support counts for interesting-variation nodes that map to said template-construction page; and
selecting the one or more pages based, at least in part, on the support counts for the interesting-variation nodes that map to said template-construction page.

20. The computer-readable storage medium of claim 14 wherein:
the computer-readable storage medium further comprises instructions for generating, for each the template-construction page, a sum of support counts;
the sum of support counts for each template-construction page is based on the support counts of all not-yet-covered interesting-variation nodes associated with the template-construction page; and
the computer-readable storage medium further comprises instructions for selecting the one or more pages based on the sum of support counts associated with the template-construction pages.

21. The computer-readable storage medium of claim 20 wherein all pages in the set of pages are used as template-construction pages.

22. The computer-readable storage medium of claim 20 further comprising instructions for:
computing a first sum of support counts for a first template-construction page;
computing a second sum of support counts for a second template-construction page;
based on the first sum of support counts, selecting the first template-construction page as a page to be annotated; and
in response to selecting the first template-construction page as a page to be annotated, re-computing the second sum of support counts for the second template-construction page.

23. The computer-readable storage medium of claim 22 wherein the step of re-computing the second sum of support counts includes reducing the second sum of support counts based on the support counts of interesting-variation nodes, associated with the second template-construction page, that are covered due to selection of the first template-construction page.

24. A computer-readable storage medium storing instructions for automatically selecting pages to surface for annotation, the instructions including instructions which, when executed by one or more processors, cause the one or more processors to perform the steps of:
during information extraction from a set of pages based on a template, detecting situations in which extraction results in empty attribute values;
in response to detecting a situation in which extraction results in empty attribute values, generating variation data that maps pages that produced empty attribute values to interesting-variation nodes of the template; and
automatically selecting one or more pages to surface for annotation based, at least in part, on said variation data.

25. The computer-readable storage medium of claim 24 wherein the step of generating variation data includes:
determining an attribute for which a particular page did not generate a value;
identifying, within the template, an interesting-variation node for the attribute; and
associating the particular page with the interesting-variation node.

26. The computer-readable storage medium of claim 25 further comprising instructions for:
determining an attribute for which a particular page did not generate a value;
incrementing a support count associated with the attribute; and
using support counts associated with attributes as a factor in selecting the one or more pages to surface for annotation.
